(19) United States
(12) Patent Application Publication
(10) Pub. No.: US 2007/0233604 A1
(43) Pub. Date: Oct. 4, 2007

(54) Software distribution

(76) Inventors: Timothy Larson, Argyle, TX (US); Richard Donald Weyrauch, Stillwater, MN (US)

Correspondence Address: CARSTENS & CAHOON, LLP, P O BOX 802334, DALLAS, TX, 75380, US

(21) Appl. No.: 11/397,584

(22) Filed: Apr. 4, 2006

(51) Int. Cl. H04L 9/00

(52) U.S. Cl. 705/52

(57) ABSTRACT

The present invention provides a method, program product and system for distributing a licensed digital product. The invention involves assigning a unique identifier to the digital product as well as each copy of the product. The invention also assigns unique identifiers to all distributors of the product. When a copy of the digital product is sold from the manufacturer to an end user through the distributors, the unique identifier of that copy is matched with the unique identifiers of all distributors who were involved in supplying the copy to the end user. After validating the purchase of the digital product a unique activation code is issued for that copy, which allows the end user to utilize the features of the product. The distributors in the supply chain that were involved in selling that particular copy of the digital product are then paid according to a pre-determined schedule.

### TECHNICAL FIELD

The present invention relates generally to a method for distribution of licensed products, and more specifically to the distribution of software or other digital content.

### BACKGROUND OF THE INVENTION

Currently, there are several channels for the distribution of licensed products, such as software and other forms of digital content. Probably the most common form of distribution comprises the content provider of software or other licensed product first selling the product to a distributor, who then sells it to a retail outlet. The retail outlet in turn sells this product to consumers. More established content providers with greater logistical resources may not need a distributor and instead sell the product directly to a retail outlet.

Alternatively, the content provider may consign inventory to a retail outlet. The retail outlet sells the product to consumers and then pays the content provider at a later date, sometimes months following the sale. In those situations where a distributor is involved, the distributor may consign inventory to the retail outlets, rather than the content provider doing so. In this case, the content provider is paid up front by the distributor, and the distributor is paid at a later date by the retailers, again sometimes months following the sale.

When using these more traditional distribution channels, the customer does not have an opportunity to use the software before purchasing it. Furthermore, most sellers of licensed software and similar digital content do not accept returns once the product has been sold, often resulting “buyer's remorse” for many consumers who do not like the product after having an opportunity to use it.

In many cases, the buyer's remorse problem has been overcome with the advent of Internet distribution and downloading. An increasingly popular distribution method comprises content providers selling or consigning trial versions of the product with a limited use license or reduced functionality (i.e. “shareware”) to a distributor and/or retail outlet. This trial version may be given away or sold for a low price to customers. In addition to downloading from the Internet, the limited use product may be delivered via ordinal mail in the form of a CD-ROM or DVD-ROM. This approach gives the customer an opportunity to try the licensed product with the option of purchasing a full use license from the content provider if he likes the product. However, the trial use distribution method generally does not allow distributors or retailers who actually supplied the trial version to be identified so that they can be paid a commission for distributing the product in the event that a customer purchases the full license.

### SUMMARY OF THE INVENTION

The present invention provides a method, program product and system for distributing a licensed digital product. The invention involves assigning a unique identifier to the digital product as well as each copy of the product. The invention also assigns unique identifiers to all distributors of the product. When a copy of the digital product is sold from the manufacturer to an end user through the distributors, the unique identifier of that copy is matched with the unique identifiers of all distributors who were involved in supplying the copy to the end user. After validating the purchase of the digital product a unique activation code is issued for that copy, which allows the end user to utilize the features of the product. The distributors in the supply chain that were involved in selling that particular copy of the digital product are then paid according to a pre-determined schedule.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 illustrates a post-activation billing system in accordance with a preferred embodiment of the present invention;

FIG. 5 shows the process flow for using the billing system in FIG. 4 for back end invoicing;

FIG. 6 shows the process flow for using the billing system in FIG. 4 for paying back end commissions;

FIG. 7 shows the process flow for the first distribution method comprising providing supply chain activation codes for prepaid UCID;

FIG. 8 shows the process flow for providing end user registration and activation codes for prepaid UCID;

FIG. 9 illustrates the process for auto-generated supply chain compensation based on paid-in-full registration of a UCID;

FIG. 10 shows the process flow for auto-generated supply chain invoicing based on paid-in-full registration of a UCID;

FIG. 11 shows the process flow for auto-generated supply chain compensation based on leased registration of a UCID; and

FIG. 12 shows the process for auto-generated supply chain invoicing based on leased registration of a UCID.

### DETAILED DESCRIPTION OF THE DRAWINGS

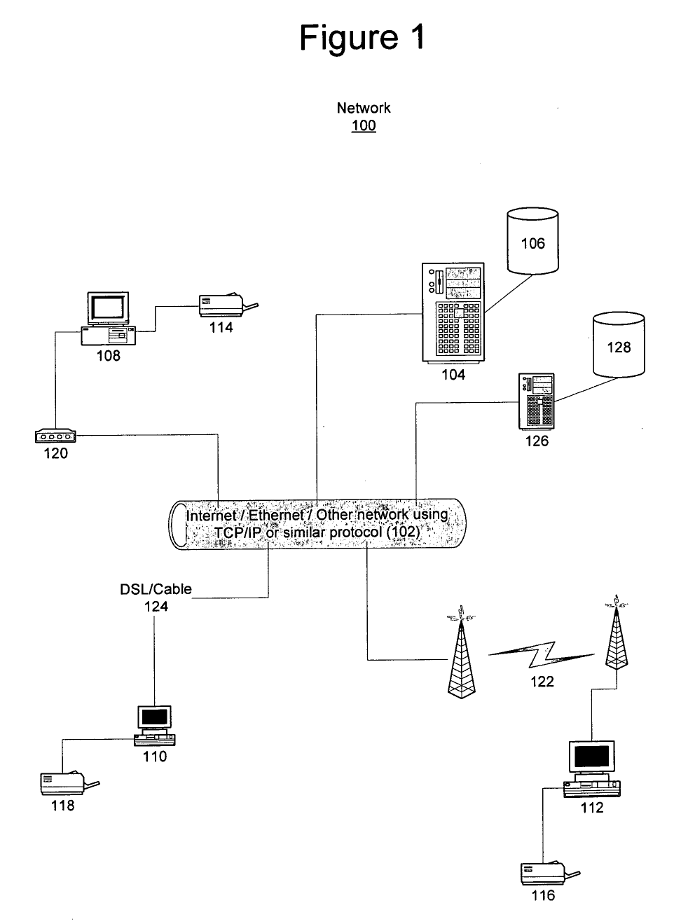

With reference now to the figures, FIG. 1 is a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Network data processing system 100 might also contain a supplementary server 126 and additional data storage 128.

Clients 108, 110, and 112 are clients to server 104. Network data processing system 100 includes printers 114, 116, and 118, and may also include additional servers, clients, and other devices not shown. The means by which clients 108-112 connect to the network 102 may include conventional telephone landline 120, broadband Digital Service Line (DSL) or cable 124, or wireless communication network 122.

In the depicted example, network data processing system 100 is the Internet with network 102 representing a worldwide collection of networks and gateways that use the TCP/IP suite or similar protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

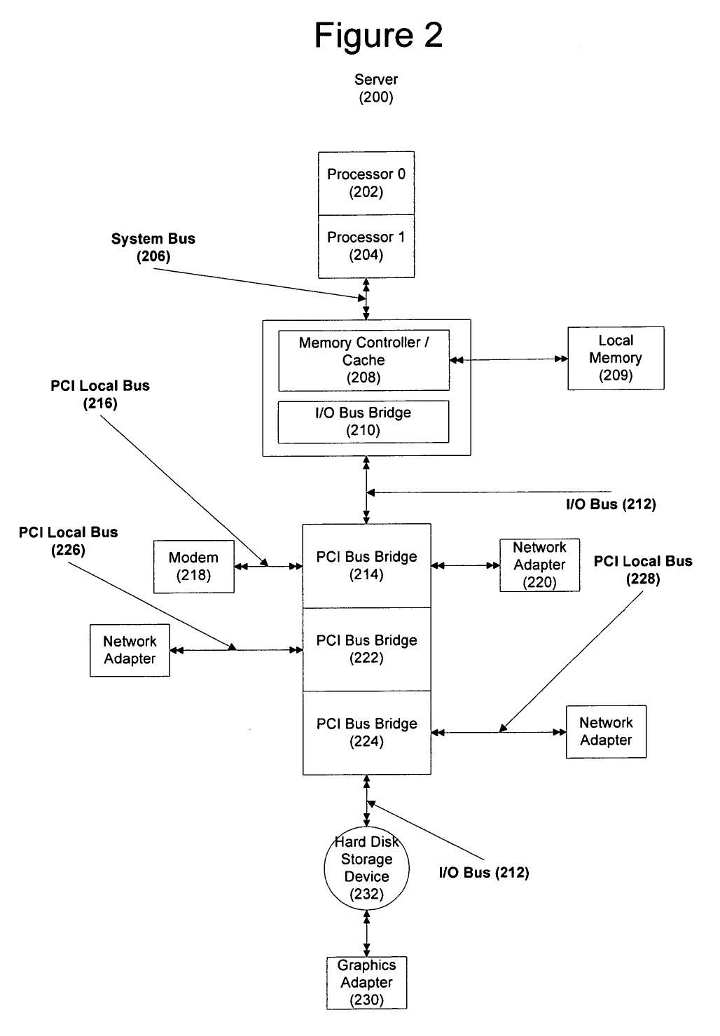

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communication links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, New York, running the Advanced Interactive Executive (AIX) or Linux operating systems.

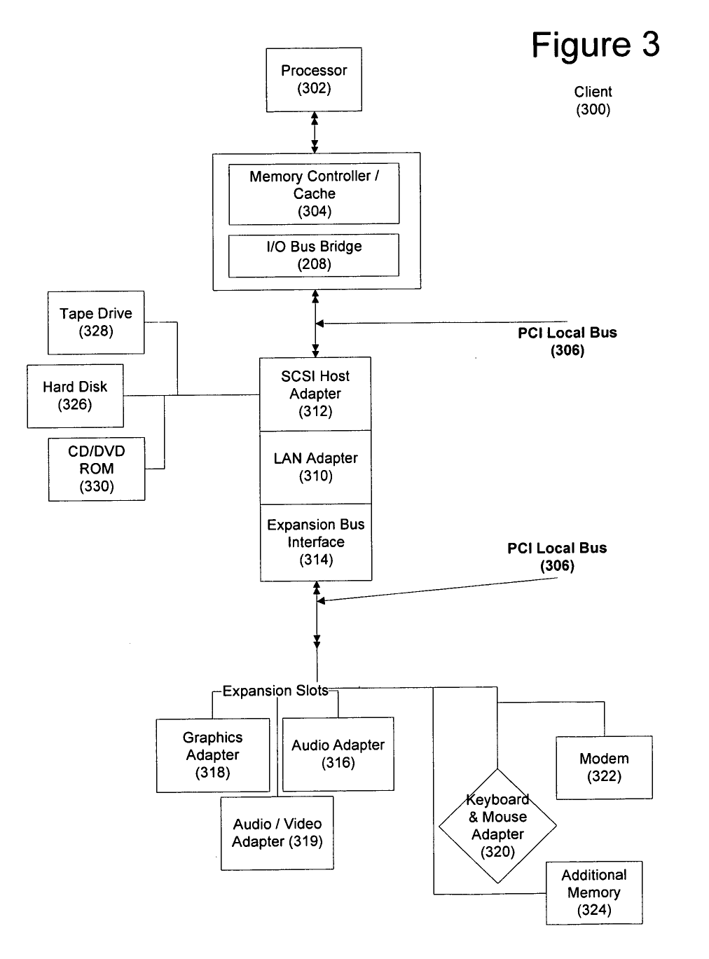

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD/DVD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and the above-described examples are not meant to imply architectural limitations. For example, data processing system 300 also may be a notebook computer or hand-held computer in addition to taking the form of a PDA. Data processing system 300 also may be a kiosk or a Web appliance.

The present invention provides protected software that is distributed via download or embodied in a physical medium (e.g., CD-ROM or DVD-ROM). The invention comprises a verification process utilized when the application loads. If the local copy is authorized, the application runs. If it is not authorized, the application terminates.

In one embodiment of the invention, a trial version is distributed either for free or for a nominal fee. After the trial period, the user has the option of purchasing a full use license that will allow continued use of the software and/or unlock all of the software's features.

The invention provides a way to automatically track and then pay the retailer and/or distributor additional payments for the sale or rental of any additional licenses. A distribution identifier uniquely identifies the particular wholesaler, retailer or distributor that actually provides the product to a customer. (For purposes of simplicity, the term “distributor” will refer to any distributor, wholesaler, retailer, or other seller of the software product.)

In the event that the customer purchases a full use license, the identifier is used to track the supply chain of from the manufacturer of the software to the retailer. Depending on the compensation system employed, payment for the product sale can move either up or down the supply chain. In one embodiment, the retailer receives payment from the end user. In this case, an invoice is generated by the manufacturer and the retailer distributes a specified percentage of the product sale to each party in the supply chain back to the manufacturer. In an alternate embodiment, payment is made from the end user directly to the manufacturer. In this case, the manufacturer pays commissions to each party in the supply chain up to the retail seller.

The distribution identifier may be implemented in a variety of manners. The identifier may be encoded or referenced in the registration information. Alternatively the information can be looked up based on product, serial number or some other number or code. Finally, the customer could identify the retail outlet from which the product media was obtained. For example, the customer may be required to enter the identifier manually as part of the purchase process. For convenience, the distribution identifier can be embedded in the software. When the user installs the software, it provides the user with the distribution identifier along with information on how to purchase a full use license.

The present invention allows the distributors and retailers to incur no or minimal initial costs for making the software available to users. The seller gets paid only after the user purchases a full use license, and the payment flows through the distribution channels to pay the parties involved in the distribution and sale of the licensed product.

The invention may make use of asymmetrical key or other encryption methods. The digital content may be encrypted or protected in a variety of methods (i.e. copy protection). The customers may at their discretion use any of a variety of methods to obtain an activation code. This product can be fully contained on the distribution media, or delivered to them by web page, email, mail media or other process. In the preferred implementation, the access key would be unique to that customer and computer or media.

The following list of definitions will help the reader better understand the descriptions of the process flows below:
Target Application—The marketed application that will be tracked by the system
UAID (Unique Application Identification): A unique identifier for the Target Application Master CD
UCID (Unique Copy Identification): A unique identifier for each copy of a Target Application—UCID are globally unique
Supply Chain Company: Any company involved in the distribution of the Target Application (including both Wholesale and Retail distribution companies)
USCID (Unique Supply Chain company Identification): A unique identifier for a participating Supply Chain Company
End Customer: The location of actual install of a Target Application's UCID copy
USID (Unique installation Site Identification): A unique ID for the Site of installation of a Target Application's UCID copy
Validation Code: A randomized code, used to protect all communications with the host system unique on a per-request basis and other required local system information. It is used as the source for a random “key” to encrypt the current registration codes (verification and activation). It may also contain system information like the site code and local computer date and time.
Activation Code: A unique code to authorize use of End Customers installed copy

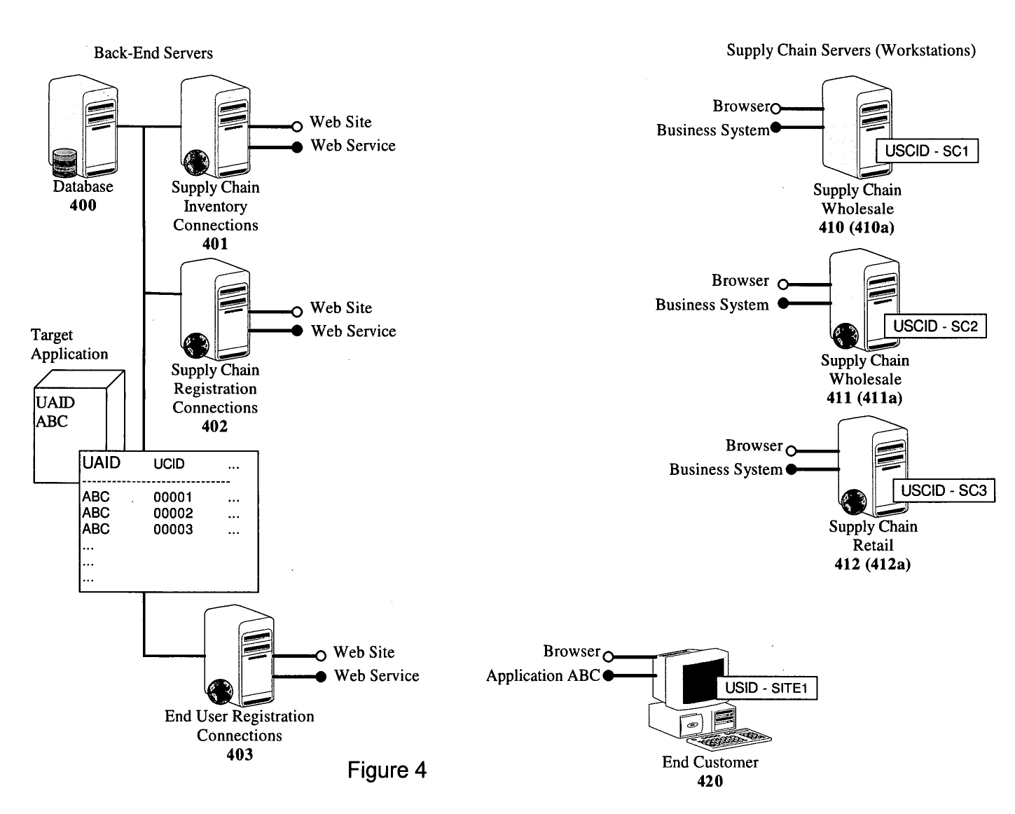

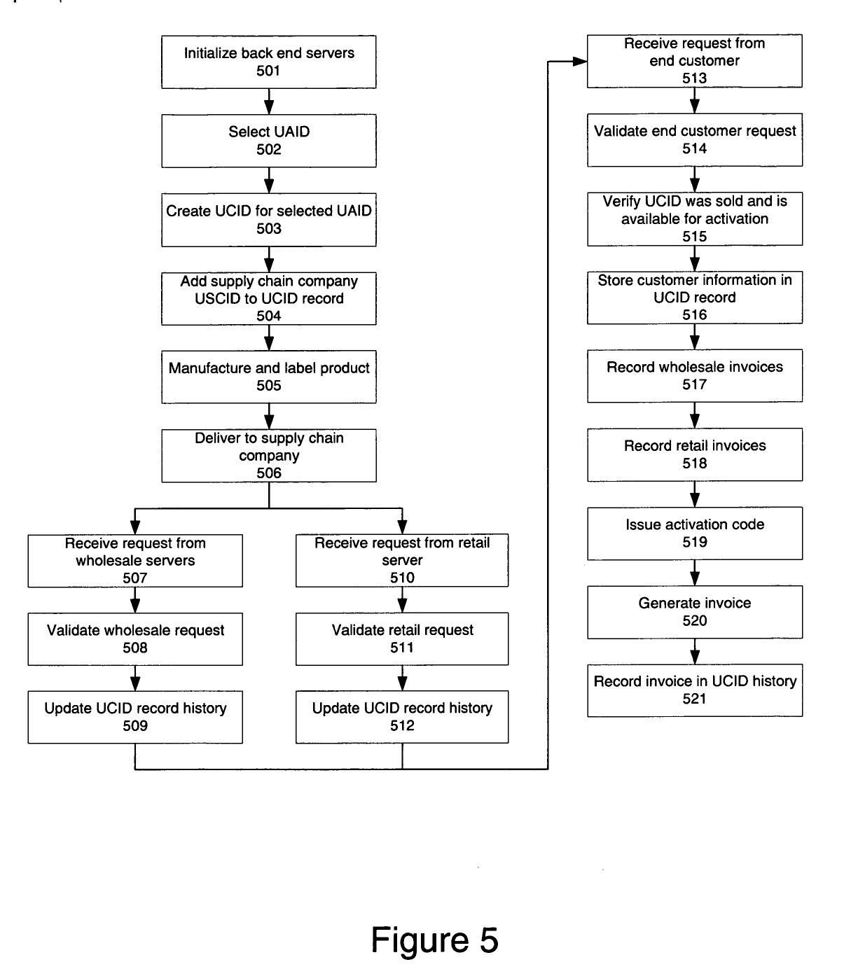

FIG. 4 illustrates a post-activation billing system in accordance with a preferred embodiment of the present invention. FIG. 5 shows the process flow for using this billing system for back end invoicing. The process begins by initializing the back-end servers (step 501). This involves preparing the database server 400 by selecting the database software of choice. The database is created with associated tables for storing the following information:
UAID associated application information
UCID associated UAID copy information
USCID associated company information
USID associated installation site information
UCID history information

The communication servers 401, 402, 403 are prepared for web hosting and supplied with the web service software of choice. Server 401 is responsible for supply chain inventory, and server 402 is responsible for supply chain registration. Server 403 handles end user registration.

Web hosting is provided for communications with remote web browsers, and web services are provided for direct system-to-system (host-to-remote) communications. All three servers 401-403, can be hosted on a single computer or multiple computers.

The next steps comprises the pre-shipping (manufacture) transactions. For a new product, a new entry is created in the UAID table (step 502). For an existing product, an active UAID would be selected from the UAID table.

A new UCID record is created for the selected UAID (step 503), and the initial Supply Chain Company is selected and its USCID is stored in the UCID record, which is added to the UCID table (step 504). The USCID is added as RetailInvoice in the UCID record history.

The product identified by the UAID is then manufactured, and that copy is then labeled with its own UCID (step 505). In the present example, the product in question will be some type of digital (software) product. Therefore, step 505 comprises reproducing a copy of that software, which is then delivered to the supply chain company identified by the USCID (step 506).

The process may include optional steps for wholesale transactions. The supply chain inventory server 401 receives a request from either of the supply chain wholesale servers 410, 411 (step 507). The server 401 validates the request by looking up the UCID record and identifying the requesting servers 410, 411 (step 508). The server 401 then updates the UCID record history (step 509). This comprises changing USCIDfrom to WholesaleInvoice and adding USCIDto as RetailInvoice.

The steps for retail transactions start with the inventory server 401 receiving a request from a supply chain retail server 412 (step 510). The server 401 validates the request by looking up the UCID record and identifying the retail server 412 (step 511). The inventory server 401 then updates the UCID record history and records the payment information (step 512).

After the product in question has been delivered, the invention registers the end user of the software. The end user registration server 403 receives a request from the end customer 420 (step 513) and validates the request by extracting the Randomize component of the validation code, extracting the USID from the validation code and looking up the UCID record (step 514). The server 403 verifies that the UCID is available for activation and that it is indeed marked “sold” by the previous wholesale or retail transaction (step 515). The registration server 403 stores the end customer's USID in the UCID record history and stores the end user registration information in the UCID record (step 516).

The registration server 403 records the wholesale invoices in the accounting system (step 517). These are derived by assessing the WholesaleInvoice USCID's in the UCID record history and the wholesale invoicing scale associated with the product UAID. The registration server 403 also records the retail invoices in the accounting system (step 518). These are derived by assessing the RetailInvoice USCIDs in the UCID record history and the retail invoicing scale of the UAID.

The server 403 then issues an activation code randomized to match the validation code (step 519).

The invention periodically generates an invoice (e.g., daily, weekly, monthly, etc.) (step 520). The accounting system processes an invoice history of un-invoiced UCIDs and prepares invoices accordingly. The accounting system then records the invoice in the UCID record history (step 521).

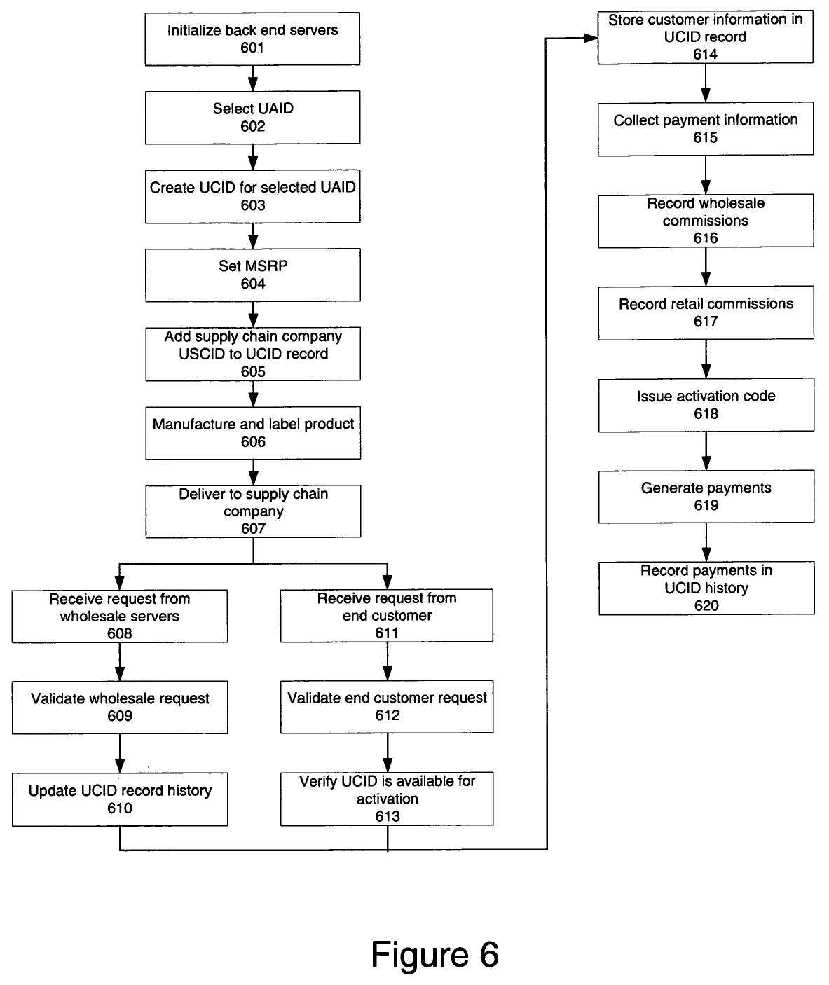

FIG. 6 shows the process flow for using the billing system in FIG. 4 for paying back end commissions. Many of the steps for this process are similar to that of the invoicing process in FIG. 5. However, in this case, the end result is a commission payment from the manufacturer to retailers and/or wholesaler in the supply chain.

The process begins by initializing the back-end servers (step 601). This involves preparing the database server 400 by selecting the database software of choice, and the database is created with associated tables for storing the following information:
UAID associated application information
UCID associated UAID copy information
USCID associated company information
USID associated installation site information
UCID history information

The next steps comprises the pre-shipping (manufacture) transactions. A new entry is created in the UAID table for a new product (step 602). For an existing product, an active UAID would be selected from the UAID table.

A new UCID record is created for the selected UAID (step 603), and a Manufacturer Suggested Retail Price (MSRP) is set in the UCID record (step 604). The MSRP is used for calculating the proper commission(s) for the supplier(s) in the supply and distribution chain as well as determining the amount to collect from the end user during the registration process.

The initial Supply Chain Company is selected and its USCID is stored in the UCID record, which is added to the UCID table (step 605). The USCID is added as RetailCommission in the UCID record history.

The product identified by the UAID is then manufactured, and that copy is then labeled with its own UCID (step 606). Again, in the present example, the product in question will be some type of software product. Therefore, step 606 comprises reproducing a copy of that software, which is then delivered to the supply chain company identified by the USCID (step 607).

As with the invoicing process, the commission payment process may include optional steps for wholesale transactions. The supply chain inventory server 401 receives a request from either of the supply chain wholesale servers 410, 411 (step 608). The server 401 validates the request by looking up the UCID record and identifying the requesting servers 410, 411 (step 609). The server 401 then updates the UCID record history (step 610). This comprises changing USCIDfrom to WholesaleCommission and adding USCIDto as RetailCommission.

After the product in question has been delivered, the invention registers the end user of the software. The end user registration server 403 receives a request from the end customer 420 (step 611) and validates the request by extracting the Randomize component of the validation code, extracting the USID from the validation code and looking up the UCID record (step 612). The server 403 verifies that the UCID is available for activation (step 613) and stores the end customer's USID in the UCID record history and stores the end user registration information in the UCID record (step 614).

The registration server 403 then collects payment information from the end user computer 420 and verifies the payment information from a third party payment service (step 615). The payment information is stored in the UCID record.

The registration server 403 records the wholesale commissions in the accounting system (step 616). These are derived by assessing the WholesaleCommission USCID's in the UCID record history and the wholesale commissions scale associated with the product UAID. The registration server 403 also records the retail commissions in the accounting system (step 617). These are derived by assessing the RetailCommission USCIDs in the UCID record history and the retail commission scale of the UAID.

The server 403 then issues an activation code randomized to match the validation code (step 618).

The invention periodically generates payments to the supply chain (e.g., daily, weekly, monthly, etc.) (step 619). The accounting system processes a commission history of unpaid UCIDs and prepares commission payments accordingly. The accounting system then records the payment in the UCID record history (step 620).

The present invention can be implemented with six specific methods of product distribution, with associated registration and accounting transactions.

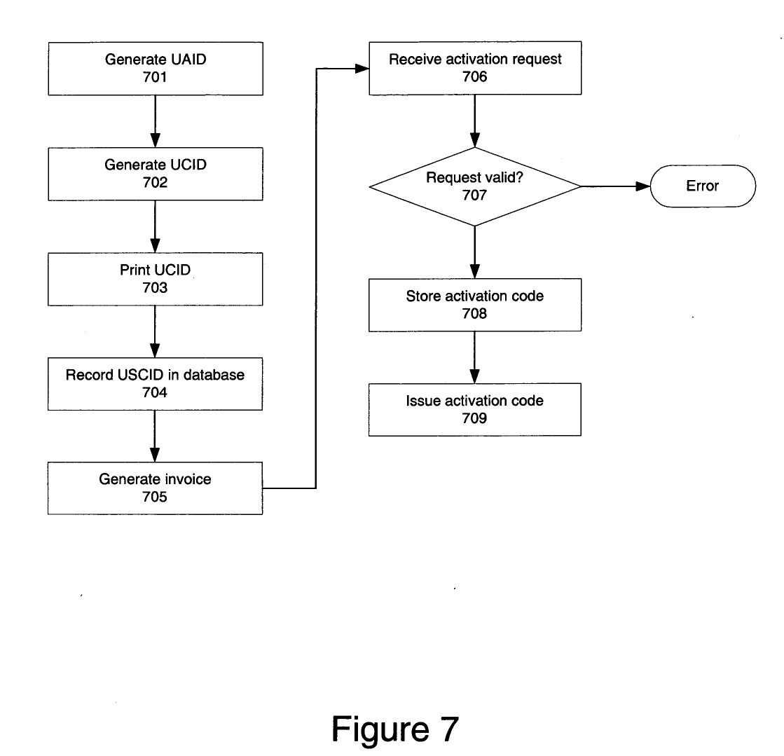

FIG. 7 shows the process flow for the first distribution method comprising providing supply chain activation codes for prepaid UCID. In this case a UCID is issued, printed, and delivered in a traditional billing cycle but the UCID owner wants to verify/control the activation of the issued UCID. The Supply Chain company is responsible for designing a registration system for their internal business system that accepts customer information reported by the embedded registration process of the application.

The steps in this process are divided into pre-shipping steps and post-shipping steps. The pre-shipping process begins by generating or selecting an existing UAID (step 701), and then generating a UCID for the selected UAID and storing the UCID in a master database (step 702). The system then prints a physical UCID for the order (step 703) and records a USCID of “Ship To” Supply Chain Company in the master database (step 704). The transaction is recorded in the accounting system to generate an invoice (step 705).

The post-shipping steps begin by receiving an activation request from the USCID business system (step 706) and validating the request and UCID availability (step 707). If the request is invalid, the system issues an error code. If the request is valid, the system stores an activation code in the master database record for the UCID (step 708) and then issues the activation code to then end user (step 709).

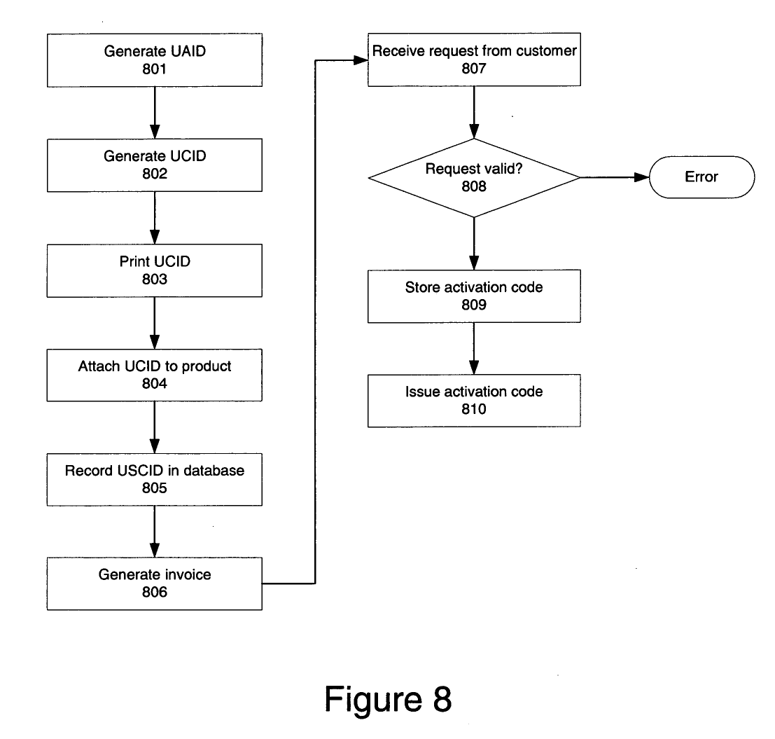

FIG. 8 shows the process flow for providing end user registration and activation codes for prepaid UCID. In this case a UCID is issued, printed and delivered in a traditional billing cycle on packaged products that will be completely registered and activated by the manufacturer's own business system. The manufacturer is responsible for designing a registration system that accepts customer information reported by the embedded registration process of the application.

Again, the process is divided between pre-shipping and post-shipping steps. The pre-shipping steps begin by generating or select an existing UAID (step 801). The system generates a UCID for the selected UAID and stores it in the master database (step 802). A physical UCID is printed (step 803) and attached to the physical product (step 804). The system records a USCID of “Ship To” Supply Chain Company in the master database (step 805), and the transaction is recorded in the accounting system to generate an invoice (step 806).

The post-shipping steps begin with receiving a request from an end customer (step 807) and validating the request and UCID availability (step 808). If the request is invalid, the system delivers an error code. If the request is invalid, the system issues an error code. If the request is valid, the system stores an activation code in the master database record for the UCID (step 809) and then issues the activation code to then end user (step 810).

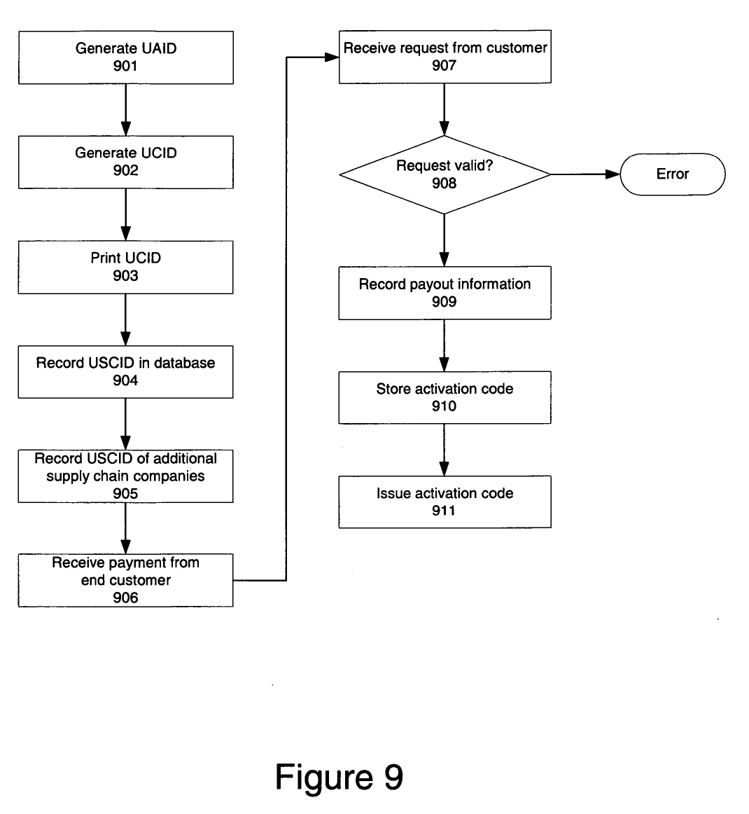

FIG. 9 illustrates the process for auto-generated supply chain compensation based on paid-in-full registration of a UCID. This process covers situations wherein a UCID is issued, printed and delivered without any associated traditional billing. The UCID may be distributed by itself, or affixed to a packaged product. This application is intended to be “unlimited use” once activated.

At the time of registration, the registration system collects payment information in addition to the customer registration information. The registration system will also record the appropriate Supply Chain payout information (commissions) according to the UAID's payment schedule.

Again, the pre-shipping steps begin with generating or selecting an existing UAID (step 901) and then generating a UCID for the UAID and storing it in the master database (step 902). The system prints a physical UCID for the order (step 903). The system then records the USCID of “Ship To” Supply Chain Company in the master database (step 904) and records the USCID of additional Supply Chain Companies in the master database (step 905).

The post-shipping steps comprise receiving payment information for the end customer (step 906) and receiving a registration request from the end customer (step 907). The system validates the request and UCID availability (step 908). Again, an error code is issued if the request is invalid. If the request is valid, the system stores an activation code in the master database for the UCID (step 909), and records payout information in the accounting system (step 910). Finally, the system issues the activation code to the end user (step 911).

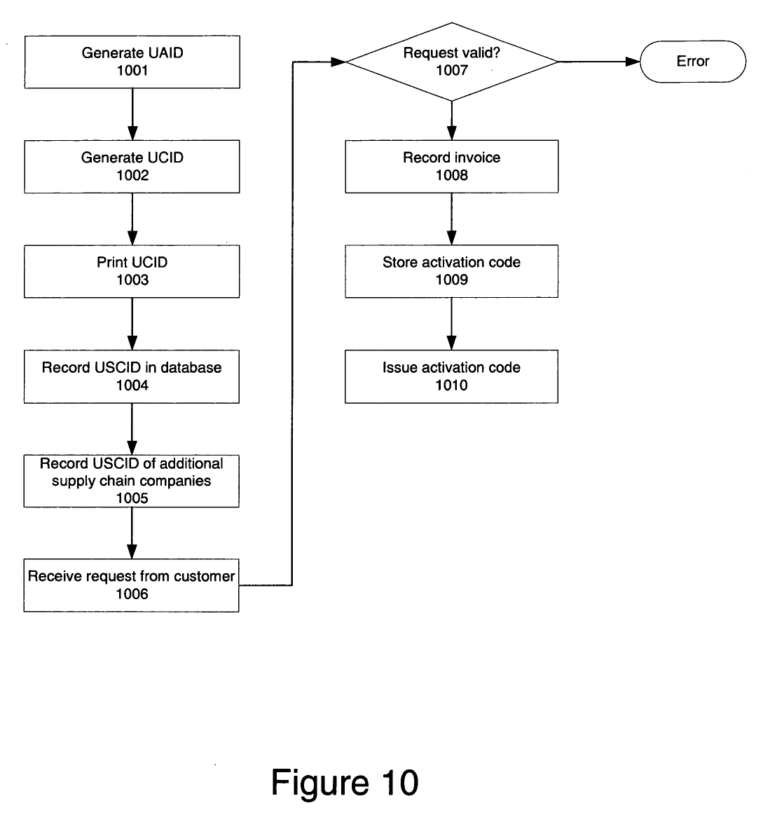

FIG. 10 shows the process flow for auto-generated supply chain invoicing based on paid-in-full registration of a UCID. As with the previous process, this one involves issuing, printing and delivering a UCID without any associated traditional billing. The UCID may be distributed by itself, or affixed to a packaged product. The application is intended to be “unlimited use” once activated.

Unlike the previous process, the registration system collects only registration information. The registration system then records the appropriate supply chain invoicing according to the UAID's payment schedule.

The pre-shipping steps for this process are the same for those of the compensation process depicted in FIG. 9. The system generates or selects an existing UAID (step 1001) and then generating a UCID for the UAID and storing it in the master database (step 1002). The system prints a physical UCID for the order (step 1003). The system then records the USCID of “Ship To” Supply Chain Company in the master database (step 1004) and records the USCID of additional Supply Chain Companies in the master database (step 1005).

The post-shipping steps begin with receiving a registration request from the end customer (step 1006), which is validated and checked for UCID availability (step 1007). An error code is issued if the request is invalid. If the request is valid, the registration system records the invoice(s) in the accounting system (step 1008) and stored the activation code for that UCID in the master database record (step 1009). Finally, the system issues the activation code to the end user (step 1010).

The following two processes involve leased registration of UCIDs, wherein end users purchase use of the software product for limited time periods.

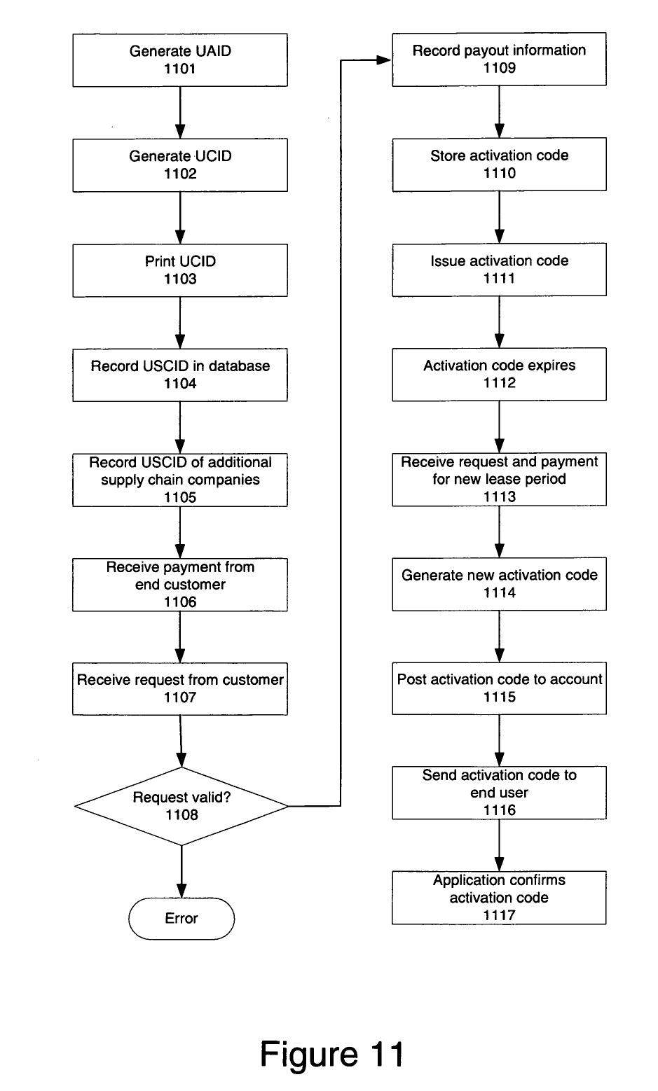

FIG. 11 shows the process flow for auto-generated supply chain compensation based on leased registration of a UCID. This process is similar to the compensation process flow depicted in FIG. 9.

As before, the pre-shipping steps begin with generating or selecting an existing UAID (step 1101) and then generating a UCID for the UAID and storing it in the master database (step 1102). The system prints a physical UCID for the order (step 1103). The system then records the USCID of “Ship To” Supply Chain Company in the master database (step 1104) and records the USCID of additional Supply Chain Companies in the master database (step 1105).

The post-shipping steps comprise receiving payment information for the end customer (step 1106) and receiving a registration request from the end customer (step 1107). The system validates the request and UCID availability (step 1108). Again, an error code is issued if the request is invalid. If the request is valid, the system records payout information in the accounting system (step 1109), and stores an activation code in the master database for that UCID (step 1110). The system then issues the activation code to the end user (step 1111).

Because the UCIDs are leased, the associated activation codes expire after a specified time period or number of transactions (step 1112). Assuming the user wishes to renew the lease, the system receives a new registration request and payment from the end user for another lease period (step 1113). A new activation code is then generated for the UCIDs for the next lease period (step 1114) and posted to the associated account in the accounting system (step 1115). The new activation code is sent to the end user (step 1116). When the end application executes again, it contacts the registration server to confirm that a new code is available (step 1117).

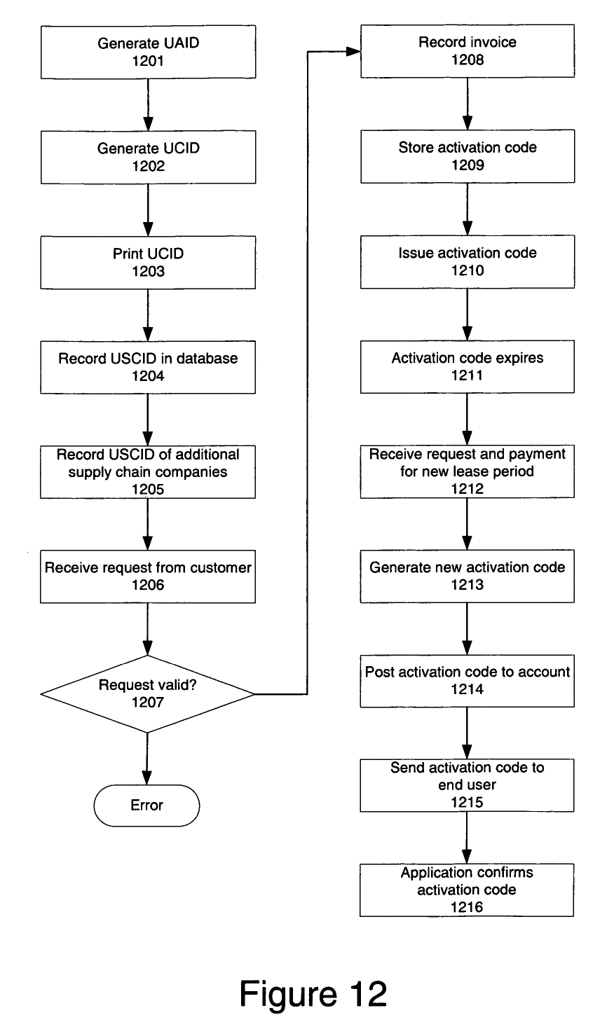

FIG. 12 shows the process for auto-generated supply chain invoicing based on leased registration of a UCID. This process is similar to the compensation process flow depicted in FIG. 10.

As with the other processes, the pre-shipping steps begin with generating or selecting an existing UAID (step 1201) and then generating a UCID for the UAID and storing it in the master database (step 1202). The system prints a physical UCID for the order (step 1203). The system then records the USCID of “Ship To” Supply Chain Company in the master database (step 1204) and records the USCID of additional Supply Chain Companies in the master database (step 1205).

The post-shipping steps begin with receiving a registration request from the end customer (step 1206), which is validated and checked for UCID availability (step 1207). An error code is issued if the request is invalid. If the request is valid, the system records invoice(s) in the accounting system (step 1208), and stores an activation code in the master database for that UCID (step 1209). The system then issues the activation code to the end user (step 1210).

Again, because the UCIDs are leased, the associated activation codes expire after a specified time period or number of transactions (step 1211). Again, assuming the user wishes to renew the lease, the system receives a new registration request and payment from the end user for another lease period (step 1212). A new activation code is then generated for the UCIDs for the next lease period (step 1213) and posted to the associated account in the accounting system (step 1214). The new activation code is sent to the end user (step 1215). When the end application executes again, it contacts the registration server to confirm that a new code is available (step 1216).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A method for distributing a licensed digital product, the method comprising the computer implemented steps of:
(a) assigning a unique identifier to a digital product;
(b) assigning unique identifiers a plurality of product distributors;
(c) selling a copy of said digital product from the manufacturer to an end user through at least one of said distributors, wherein said copy has a unique identifier;
(d) validating the purchase of said copy of the digital product by said end user;
(e) if said purchase is valid, issuing a unique activation code for said copy, wherein said activation code allows said end user to utilize the features of the digital product;
(f) matching the unique identifier of said copy of the digital product with the unique identifiers of all distributors who were involved in supplying said copy to said end user in step (c); and
(g) paying said distributors from step (f) according to a pre-determined schedule.

2. The method according to claim 1, wherein step (d) further comprises:
receiving a registration request from the end user that includes the unique identifier of said copy of the digital product; and
looking up a record history of said copy to confirm that it has been reported as sold by one of said distributors and is available to be activated for use by said end user.

3. The method according to claim 2, further comprising storing a unique identifier for the end user in the record history of said copy of the digital product.

4. The method according to claim 1, wherein if the end user pays the manufacturer directly for the purchase of said copy of the digital product, step (g) further comprises paying commissions from the manufacturer to the distributors in step (f).

5. The method according to claim 1, wherein if the end user pays a retail distributor for the purchase of said copy of the digital product, step (g) further comprises generating an invoice for said retailer detailing payments due from the retailer to the distributors in step (f) and the manufacturer.

6. The method according to claim 1, wherein said copy of the digital product is leased by the end user for a limited period of time, after which said activation code expires.

7. The method according to claim 6, wherein after the activation code has expired, a new activation code is generated for said copy of the digital product, wherein said new activation code is valid for a new limited time period.

8. A computer program product in a computer readable medium, for distributing a licensed digital product, the computer program product comprising:
(a) first instructions for assigning a unique identifier to a digital product;
(b) second instructions for assigning unique identifiers a plurality of product distributors;
(c) third instructions for validating the purchase of a copy of the digital product by an end user, wherein said copy the digital product is sold from the manufacturer to the end user through at least one of said distributors, wherein said copy has a unique identifier;
(d) if said purchase is valid, fourth instructions for issuing a unique activation code for said copy, wherein said activation code allows said end user to utilize the features of the digital product;
(e) fifth instructions for matching the unique identifier of said copy of the digital product with the unique identifiers of all distributors who were involved in supplying said copy to said end user in part (c); and
(f) sixth instructions for calculating payments to said distributors from part (e) according to a pre-determined schedule.

9. The computer program product according to claim 8, wherein the third instructions (c) further comprise:
instructions for receiving a registration request from the end user, wherein the registration request includes the unique identifier of said copy of the digital product; and
instructions for looking up a record history of said copy to confirm that it has been reported as sold by one of said distributors and is available to be activated for use by said end user.

10. The computer program product according to claim 9, further comprising instructions for storing a unique identifier for the end user in the record history of said copy of the digital product.

11. The computer program product according to claim 10, wherein if the end user pays the manufacturer directly for the purchase of said copy of the digital product, part (f) further comprises instructions for paying commissions from the manufacturer to the distributors in part (e).

12. The computer program product according to claim 10, wherein if the end user pays a retail distributor for the purchase of said copy of the digital product, part (f) further comprises instructions for generating an invoice for said retailer detailing payments due from the retailer to the distributors in part (e) and the manufacturer.

13. The computer program product according to claim 10, wherein said copy of the digital product is leased by the end user for a limited period of time, after which said activation code expires.

14. The computer program product according to claim 13, wherein after the activation code has expired, a new activation code is generated for said copy of the digital product, wherein said new activation code is valid for a new limited time period.

15. A system for distributing a licensed digital product, the system comprising:
(a) a product database that assigns a unique identifier to a digital product;
(b) a distributor database that assigning unique identifiers a plurality of product distributors;
(c) a registration database that validates the purchase of a copy of the digital product by an end user, wherein said copy the digital product is sold from the manufacturer to the end user through at least one of said distributors, wherein said copy has a unique identifier;
(d) if said purchase is valid, an activation mechanism that issues a unique activation code for said copy, wherein said activation code allows said end user to utilize the features of the digital product;
(e) a sale record database that matches the unique identifier of said copy of the digital product with the unique identifiers of all distributors who were involved in supplying said copy to said end user in part (c); and
(f) an accounting mechanism that calculates payments to said distributors from part (e) according to a predetermined schedule.

16. The system according to claim 15, wherein part (c) further comprise:
an input mechanism for receiving a registration request from the end user, wherein the registration request includes the unique identifier of said copy of the digital product; and
a record history of said copy that confirms if the copy has been reported as sold by one of said distributors and is available to be activated for use by said end user.

17. The system according to claim 16, wherein the record history of said copy of the digital product further comprises a unique identifier for the end user.

18. The system according to claim 15, wherein if the end user pays the manufacturer directly for the purchase of said copy of the digital product, the accounting mechanism in part (f) further comprises a payment mechanism for paying commissions from the manufacturer to the distributors in part (e).

19. The system according to claim 15, wherein if the end user pays a retail distributor for the purchase of said copy of the digital product, the accounting mechanism in part (f) further comprises an invoicing mechanism for generating an invoice for said retailer detailing payments due from the retailer to the distributors in part (e) and the manufacturer.

20. The system according to claim 15, wherein said copy of the digital product is leased by the end user for a limited period of time, after which said activation code expires.

21. The system according to claim 20, wherein after the activation code has expired, a new activation code is generated for said copy of the digital product, wherein said new activation code is valid for a new limited time period.
